(19) United States
(12) Patent Application Publication
(10) Pub. No.: US 2003/0093318 A1
(43) Pub. Date: May 15, 2003

(54) Advertisment distribution methos, server terminal, user terminal, and program

(75) Inventors: Kaoru Komaki, Minato-Ku (JP); Masakazu Inoue, Minato-Ku (JP); Shinichi Takahashi, Minato-Ku (JP); Masato Tomita, Minato-Ku (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/291,518

(22) Filed: Nov. 12, 2002

(30) Foreign Application Priority Data
Nov. 9, 2001 (JP) 2001-345436
Dec. 18, 2001 (JP) 2001-384982
Aug. 20, 2002 (JP) 2002-238838

(51) Int. Cl. G06F 17/60

(52) U.S. Cl. 705/14

(57) ABSTRACT

The present invention is directed toward realizing the distribution of advertisements that can attract the attention of users to advertisements and thus maximize the effect of the advertisements. A matching table stores correspondence information for linking advertisement information to events that are to be reported to user terminals. The event recognition unit of a server terminal recognizes the occurrence of an event that is to be reported to a user terminal, and a matching unit refers to the matching table and specifies the advertisement information that has been linked to the event that has been recognized. A distribution control unit, instead of performing a process of reporting the recognized event to the user terminal by way of the communication network, fetches the specified advertisement information from an advertisement storage unit and transmits the specified advertisement information to the user terminal by way of the communication network. The user of the user terminal recognizes the event that is reported from the advertisement information that has been distributed.

### BACKGROUND OF THE INVENTION

1. Field of the Invention

The present invention relates to a method and system of distributing advertisements in which advertisement information is distributed from a server terminal to user terminals via a communication network.

2. Description of the Related Art

The popularization of communication networks such as the Internet or mobile communication networks has led to widespread distribution of advertising that uses communication networks. In a typical method for distributing advertisements, advertisement information or electronic mail, messages, and files that contain advertisement information are distributed from a server terminal to an unspecified multiplicity of user terminals. There also exist methods in which users that access from user terminals are shown advertisement information such as banner advertisements or pages and files that contain such information.

Banner advertising or methods of distributing advertisement information or messages that contain advertisement information to an unspecified multiplicity of user terminals suffer from the problems that users pay little attention or often fail to look at all of the advertisement information, and this type of advertising therefore has little effect in return for the cost to the advertiser. There is also the problem that methods that involve unilateral transmission of advertisement information to an unspecified multiplicity of user terminals may in some cases be an unwelcome nuisance to users. A variety of methods have therefore been proposed with the object of raising the effectiveness of advertising.

As an example, Japanese Patent Laid-open No. 2002-133288 (Reference 1) proposes a mail distribution system in which syntax analysis and semantic analysis are carried out for the main text of mail when distributing mail to determine advertisement information having a close relevance to the text of the mail, advertisement information that has been determined then being inserted into the header or footer of the mail and distributed. A method of distributing advertisements resembling this method is also proposed in Japanese Patent Laid-open No. 2000-270013 (Reference 2).

Japanese Patent Laid-open No. 2001-76001 (Reference 3) proposes a method of distributing advertisements in which a server terminal having the function of a calendar service for registering and referring to users' schedule information for user terminals, in response to a user terminal that has requested reference to schedule data of a particular day, selects advertisement information having close relevance to the requested schedule data and transmits this advertisement information to the user terminal together with the schedule data.

Japanese Patent Laid-open No. 2002-32591 (Reference 4) proposes a method of distributing advertisements in which a content provider, in accordance with a user's request, photographs and records the announcement content of an information-generating site of an event such as a lecture, publishes on its own home page via the Internet the lecture topic of the information-generating site, and at the same time, notifies the user by electronic mail that the lecture topic of the information-generating site that has been requested has been published on the home page. When the user accesses the home page and selects the information-generating site, the content provider attaches advertisements that have been selected based on personal information of the user to material such as the photographed content of the information-generating site and distributes it to the user.

In each of the methods of distributing advertisements of the prior art proposed in the above-described References 1 to 4, the effect of advertising is raised by distributing advertisement information that may hold interest for the user that receives mail, messages, or files. However, since the content that is absolutely indispensable to the person receiving the mail is the original mail text or message text and not the advertisement information that is attached to the mail, there is no guarantee that the user will pay attention to the advertisement information, and the effect of the advertisement is therefore not necessarily enhanced.

### SUMMARY OF THE INVENTION

It is an object of the present invention to enable drawing a user's attention to an advertisement and thus maximize the effect of advertising.

The method of distributing advertisements of the present invention takes as its basis executing, in place of a process of reporting an event from a server terminal to a user terminal by way of a communication network, a process at the server terminal of controlling the distribution to the user terminal of advertisement information that corresponds to the event that is reported.

More specifically, the occurrence of an event that is to be reported to a user terminal is recognized at a server terminal and, instead of a process of reporting the recognized event to the user terminal by way of a communication network, a process is executed at the server terminal for controlling the distribution to the user terminal of advertisement information that corresponds to the event that is reported.

Alternatively, the occurrence of an event that is to be reported to a user terminal is recognized at a server terminal, advertisement information that has been linked to the recognized event is specified at the server terminal, and, instead of a process for reporting the recognized event to the user terminal by way of the communication network, a process is executed at the server terminal for controlling the distribution of the specified advertisement information to the user terminal.

The server terminal of the present invention takes as its basis executing, instead of a process for reporting an event to a user terminal by way of a communication network, a process for controlling the distribution to the user terminal of advertisement information that corresponds to the event that is reported.

More specifically, the server terminal of the present invention is provided with an event recognition means for recognizing the occurrence of an event that is to be reported to a user terminal; and distribution control means for executing, instead of a process for reporting the recognized event to the user terminal by way of a communication network, a process for controlling the distribution to the user terminal of advertisement information that corresponds to the event that is reported.

Alternatively, the server terminal of the present invention is provided with: event recognition means for recognizing the occurrence of an event that is to be reported to a user terminal; matching means for specifying advertisement information that is linked to the recognized event; and distribution control means for executing, instead of a process for reporting the recognized event to the user terminal by way of the communication network, a process for controlling distribution of specified advertisement information to the user terminal.

A user terminal of the present invention is basically provided with: registration means for registering in a server terminal by way of a communication network correspondence information that links advertisement information with an event for which a report is to be received from the server terminal; and processing means for, when the server terminal, instead of executing a process for reporting an event, refers to the correspondence information and executes a process for controlling the distribution to that user terminal of the advertisement information that corresponds to the event that is reported, executing a process that accords with the process for controlling distribution that is executed.

The distribution control process in the server terminal may be a process of transmitting advertisement information to a user terminal by way of a communication network. In this case, instead of reporting an event, advertisement information that corresponds to the event is transmitted from the server terminal to the user terminal and received at the user terminal. The user of the user terminal, by recognizing the received advertisement information, can recognize the report of the event that corresponds to the advertisement information.

The process of controlling distribution at the server terminal may be a process in which a request to reproduce advertisement information that has been stored in advance in the user terminal is transmitted to the user terminal by way of a communication network. In this case, instead of reporting an event, a request to reproduce advertisement information that corresponds to the event is transmitted from the server terminal to the user terminal, whereby the advertisement information that has been stored in the user terminal is reproduced. By recognizing the advertisement information that is reproduced, the user of the user terminal can recognize the report of the event that corresponds to the advertisement information.

The process of controlling distribution in the server terminal may be a process for halting the process of transmitting advertisement information to the user terminal by way of a communication network. In this case, instead of reporting an event, the process of transmitting advertisement information that corresponds to the event from a server terminal to a user terminal is halted, whereby the reception of the advertisement information is halted in the user terminal. The user of the user terminal, by recognizing the halt of the reception of advertisement information that was being received, can recognize the report of the event that corresponds to the advertisement information.

In the server terminal, the process of controlling distribution may be a process for transmitting, to the user terminal by way of a communication network, a request to halt reproduction of advertisement information that was being reproduced in the user terminal. In this case, instead of reporting the event, the server terminal transmits a request to the user terminal to halt the reproduction of advertisement information that corresponds to the event, whereby the reproduction of advertisement information that was stored in the user terminal is halted. The user of the user terminal, by recognizing the halt of reproduction of advertisement information that up to this time was being reproduced, can recognize that the report of the event that corresponds to the advertisement information.

In this case, the server terminal may refer to correspondence information that links an event and advertisement information and specify advertisement information that corresponds to the event that is to be reported. Correspondence information may be information that links one or a plurality of items of advertisement information to one event, or may be information that links one or a plurality of items of advertisement information to a logical condition of a plurality of events. This correspondence may be common to all user terminals, or may implemented for one or each of a plurality of user terminals. In such a case, the correspondence may also be implemented by users of user terminals.

In the present invention, instead of a process of reporting an event from a server terminal to a user terminal by way of a communication network, a process is executed for controlling the distribution to user terminals of advertisement information that corresponds to events that are to be reported. As a result, for the users of the user terminals, advertisement information that is subjected to distribution control is therefore not incidental information, but rather, information that is indispensable for learning of events that are reported. The attention of a user can thus be drawn to the advertisement information, whereby the effectiveness of the advertisement can be maximized.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram of an embodiment of the present invention.

FIG. 2 is a flow chart showing an example of the operations of an embodiment of the present invention.

FIG. 3 is a block diagram showing a working example of an embodiment of the present invention.

FIG. 4 shows an example of the construction of a matching table that is used in a working example of the present invention.

FIG. 5 is a flow chart showing an example of processing when registering correspondence information in the matching table in a working example of the present invention.

FIG. 6 shows an example of a menu that is displayed on the screen of a user terminal when registering correspondence information in the matching table in a working example of the present invention.

FIG. 7 shows the registered state of a new event in the matching table in a working example of the present invention.

FIG. 8 is an explanatory view of a working example of the present invention.

FIG. 9 is a flow chart showing an example of the processing of a server terminal in a working example of the present invention.

FIG. 10 shows an example of a matching table in another working example of the present invention.

FIG. 11 shows an example of a matching table in another working example of the present invention.

FIG. 12 shows an example of a matching table in another working example of the present invention.

FIG. 13 shows an example of a matching table in another working example of the present invention.

FIG. 14 shows an example of a matching table in another working example of the present invention.

FIG. 15 shows an example of a matching table in another working example of the present invention.

FIG. 16 is a flow chart showing an example of the processing of a server terminal in another working example of the present invention.

### DETAILED DESCRIPTION OF THE PREFERRED EMBODIMENTS

Embodiments of the present invention are next described in detail with reference to the accompanying figures.

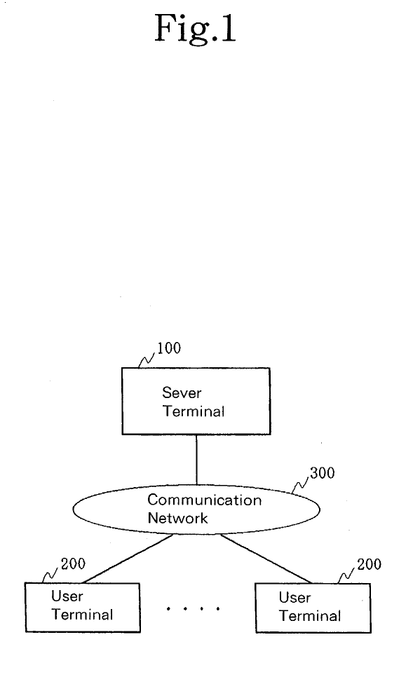

We refer first to FIG. 1, which shows an embodiment of the present invention in which server terminal 100 and a plurality of user terminals 200 are connected together so as to allow communication with each other by way of communication network 300 such as a LAN, WAN, mobile communication network, or the Internet.

Server terminal 100 recognizes the occurrence of an event that is to be reported to user terminals 200, specifies advertisement information that has been linked with the recognized event, and has the capability to execute a process for controlling the distribution of the specified advertisement information to user terminals 200 instead of a process for reporting the recognized event to user terminals 200 by way of communication network 300. Explanation next regards “event,” “advertisement information,” “linking an event and advertisement information,” and “process of controlling distribution.”

An event may be any happening for which the occurrence can be recognized by a device, a system, a program, or a person. In other words, an event may be anything for which occurrence can be recognized by measurement or observation by a specific means (an observed event), may be something for which occurrence can be recognized by the event itself (a spontaneous event), or may be something for which occurrence can be reported from another system, person, or function and thus recognized (a reported event). An observed event is an occurrence such as “rain fell,” and the occurrence of this event can be recognized by observation by meteorological measurement devices. A spontaneous event is an occurrence such as “It is now a specific time,” and the occurrence of this event can be recognized spontaneously when a timer reaches a set time. A reported event is an occurrence such as “Tickets to a particular singer's performance are now on sale,” and the occurrence of this event can be recognized by means of a report from a system that handles information regarding ticket sales, i.e., another system, this information being reported by way of a communication network.

Although the types of event have here been divided between observed events, spontaneous events, and reported events, the specification of the types of event is not of key importance in the present invention, and as previously described, any event for which the occurrence can be recognized by means of a device, system, program, or person can be treated as an “event” in the present invention. For example, the present invention can handle as events occurrences such as the arrival of mail having a specific content, designating a specific destination, and from a specific person in a mail server, or the publishing of a lecture topic at an information-generating site that has been requested by a user on the home page of a content provider such as described in Reference 4.

The present invention places no restrictions on how an occurrence that is recognized and treated as an event takes place, i.e., no restrictions are placed on the occurrence of an event, the cessation of an event, the beginning of a continued event, the halt of a continued event, the continuation of a fixed interval or a set number of times of an event, or the cessation of a fixed interval or fixed number of times of an event. The occurrence of an event is, for example, “the occurrence of an accident at a railroad crossing.” The cessation of an event is, for example, “the halt of operation of trains.” The beginning of a continued event is, for example, “the start of rainfall that is likely to continue.” The cessation of a continued event is, for example, “the halt of rainfall.” The continuation of a set period or set number of times of an event is, for example, “rain continued to fall for one hour.” The cessation of a fixed interval or fixed number of times of an event is, for example, “The halt of train operation lasted for one hour.”

The occurrence of an event may be searched and recognized by server terminal 100. Alternatively, an event may be reported to server terminal 100 by preparing an event occurrence detector and searching another server in communication network 300 at fixed intervals. Alternatively, an event may be reported to server terminal 100 by monitoring an event that is received by manual input within communication network 300. Further, an event may be reported to server terminal 100 by using another information providing server to monitor the occurrence of events on communication network 300.

Further, a condition that logically combines a plurality of the above-described events may be treated as a single event. A logical condition of a plurality of events is a logical product (AND), a logical sum (OR), a logical NOT, or a combination of these conditions. For example, the occurrence of the event “Rain continued to fall for one hour, and the halt of train operations lasted for one hour,” which is the logical product of the event “Rain continued to fall for one hour” and the event “The halt of train operations lasted for one hour,” may be recognized as one event. This recognition function can be realized by a normal logical circuit or program process.

Next, “advertisement information” is information for publicizing a particular product, service, or event. The type of information can vary freely among any one of text, still images, moving images, speech, or music, or may be any combination of these forms.

“Linking an event and advertisement information” may be a 1:1 correspondence, i.e., one item of advertisement information for one event; or may be a 1:n correspondence, i.e., a plurality of items of advertisement information for one event. Alternatively, a n:1 correspondence is also possible in which one item of advertisement information is linked to a logical condition of a plurality of events; or an n:n correspondence is possible in which a plurality of items of advertisement information are linked to a logical condition of a plurality of events. In this case, a logical condition of a plurality of events is a logical product (AND), a logical sum (OR), a logical NOT, or a combination of these conditions. This is similar to, for example, linking a particular item or plurality of items of advertisement information with the logical sum condition of a particular event A and another event B. The events A and B mentioned here obviously can include events that are prescribed by conditions that logically combine a plurality of events as described in the explanatory section on events. As an example, event A is similar to an event that is the logical product of a particular event A1 and another event A2.

Linking events and advertisement information may be a process performed by someone other than the user of user terminal 200, for example, an advertiser or manager of server terminal 100, and this correspondence may be established as correspondence information in server terminal 100. In this case, the correspondence between an event and advertisement information may be defined in common at all user terminals 200 or at unspecified user terminals 200, or may be defined at one or at each of a plurality of user terminals 200. Alternatively, the correspondence between events and advertisement information may be established for each user terminal 200 or for each user group that is composed of a plurality of user terminals 200 by the user of user terminal 200 or the users of the user group, this correspondence being unique to that user terminal 200 or user group.

The advertisement information that corresponds to an event may be actual values of advertisement information, or may be class information of advertisement information. Actual values of advertisement information are items of actual advertisement information that publicize a certain specific product or service of a certain specific advertiser. In contrast, class information of advertisement information is a whole range of advertisement information that concerns a product or service that is related to a certain specific advertiser, or a whole range of advertisement information that concerns products or services that pertain to a certain field. As an example, while advertisement information that relates to a specific car X that is marketed by automobile manufacturer A is an actual value, advertisement information that relates to any type of vehicle marketed by automobile manufacturer A is class information. Any advertisement information that relates to automobiles regardless of the manufacturer is also class information. When linking an event and class information of advertisement information, the actual values of advertisement information are selected in server terminal 100 by any algorithm from among the plurality of actual values that are subordinate to the class, and these actual values are distributed as the advertisement information that corresponds to that event. By recognizing the class of advertisement information that has been subjected to distribution control, a user recognizes the event that has been reported.

The process of controlling distribution refers to a control process for implementing the distribution of advertisement information that corresponds to an event from server terminal 100 to user terminal 200 by way of communication network 300. In the case of the present embodiment, the process of controlling distribution can take the following forms:

(1) A process for transmitting advertisement information that corresponds to an event that is to be reported to user terminal 200 by way of communication network 300.

(2) A process for transmitting to user terminal 200 by way of communication network 300 a request to reproduce advertisement information that corresponds to an event that is to be reported, this advertisement information being included among one or a plurality of items of advertisement information that have been stored in advance in user terminal 200.

(3) A process for halting a process for transmitting to user terminal 200 by way of communication network 300 advertisement information that corresponds to an event that is to be reported.

(4) A process for transmitting to user terminal 200 by way of communication network 300 a request to halt the reproduction of advertisement information that is being reproduced at user terminal 200, this advertisement information corresponding to an event that is to be reported.

When the process of controlling distribution that is described in the above first item is carried out, instead of an event being reported, advertisement information that corresponds to the event is transmitted to user terminal 200 from server terminal 100 and received at user terminal 200. The user of user terminal 200 can recognize the report of the event that corresponds to this advertisement information by recognizing the advertisement information that has been received.

When the process of controlling distribution that is described in the above second item is carried out, a request is transmitted to user terminal 200 by way of communication network 300 to reproduce, of advertisement information that has been stored in advance in user terminal 200, the advertisement information that corresponds to the event that is to be reported, whereby the advertisement information is reproduced at user terminal 200. The user of user terminal 200 thus can recognize the report of the event that corresponds to this advertisement information by recognizing the reproduced advertisement information.

When the process of controlling distribution that is described in the above third item is carried out, instead of reporting an event, a process for transmitting advertisement information that corresponds to the event from server terminal 100 to user terminal 200 is halted, whereby the reception of advertisement information is halted in user terminal 200. The user of user terminal 200 can thus recognize the report of the event that corresponds to the advertisement information by recognizing the cessation of the advertisement information that was being received.

When the process of controlling distribution that is described in the above fourth item is carried out, instead of reporting an event, a request to halt the reproduction of advertisement information that corresponds to the event is transmitted from server terminal 100 to user terminal 200, whereby the reproduction of the advertisement information at user terminal 200 is halted. The user of user terminal 200 is thus able to recognize the report of the event that corresponds to the advertisement information by recognizing the cessation of the reproduction of the advertisement information that was being reproduced.

In addition, the transmission and reproduction of advertisement information by means of the process of controlling distribution of the above-described first and second points can be performed a single time or continuously, and the form of continuation is open to variation. In other words, the transmission and reproduction of the advertisement information may be performed just one time, or the transmission and reproduction of the advertisement information may be performed continuously. In addition, when the transmission and reproduction of the advertisement information are to be performed continuously, a time limit may be provided such that transmission and reproduction are continued for a predetermined fixed time or continued only for the period in which the event occurs. Still further, as the form of continuation, the transmission and reproduction may be continuous, the transmission and reproduction may be repeated at intervals, the transmission and reproduction may be repeated intermittently, or the transmission and reproduction may be repeated non-continuously and at irregular intervals.

In addition, the halt of transmission and halt of reproduction of the advertisement information according to the processes of controlling distribution of the above-described third and fourth points may be provided with a time limit whereby the transmission and reproduction are halted only for a predetermined fixed time period, or whereby the transmission and reproduction are halted only for the time period in which the event occurs.

Explanation next regards the functions of user terminal 200.

When server terminal 100 executes, instead of a process in which server terminal 100 reports an event to user terminal 200, a process of controlling the distribution by way of communication network 300 to user terminal 200 of advertisement information that corresponds to an event that is reported, user terminal 200 has the capability of performing a process that accords with the executed distribution control process. User terminal 200 preferably has the capability to register, in server terminal 100 by way of communication network 300, correspondence information that links an event that is to be reported from server terminal 100 to advertisement information. Four examples have been provided in the foregoing explanation regarding the process of controlling distribution on the server terminal 100 side, and in each of these cases, user terminal 200 carries out respective processing as described below.

(1) When advertisement information that corresponds to an event that is to be reported is transmitted from server terminal 100 by way of communication network 300, user terminal 200 receives the advertisement information. User terminal 200 may immediately display and output the received advertisement information and present the advertisement information to the user, or may store the advertisement information in a storage device of user terminal 200 and wait for instructions from the user to present the advertisement information. In such a case, prescribed control information may be included in the advertisement information, and the advertisement information may be, for example, saved in a storage device at user terminal 200 that has received the advertisement information, whereby the input of information by a specific operation such as the input of a code number may then obtain a state that allows the user to view the advertisement information at user terminal 200, for example, by displaying the advertisement. In addition, these capabilities may be realized by providing prescribed control functions on the side of user terminal 200. The provision of such prescribed control functions allows the user of user terminal 200 to deal with cases in which viewing is not possible at the time the advertisement information is received.

(2) When a request is transmitted from server terminal 100 by way of communication network 300 to reproduce, of a plurality of items of advertisement information that have been stored in advance in user terminal 200, advertisement information that corresponds to an event that is to be reported, the advertisement information that is designated by the reproduction request is read from the storage device of that user terminal 200 and a reproduction process such as display or output is carried out.

(3) When server terminal 100 halts the process of transmitting, to the terminal 200 by way of communication network 300, advertisement information that corresponds to an event that is reported, the process of receiving the advertisement information is halted.

(4) When server terminal 100 transmits by way of communication network 300 a request to halt the reproduction of advertisement information that corresponds to a reported event, the reproduction of the advertisement information that is designated by the reproduction halt request is halted.

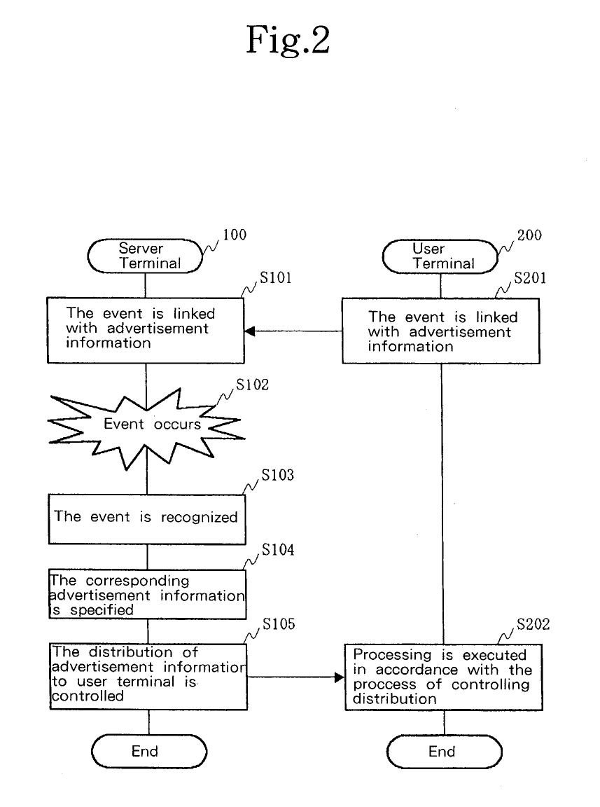

Explanation next regards the operation of the present embodiment with reference to FIG. 1 and FIG. 2.

The manager of server terminal 100 first defines correspondence information that links an event that is to be reported to the user of user terminal 200 with advertisement information, and sets this correspondence information in the storage device of server terminal 100 (S101). The correspondence information may also be defined by the user of user terminal 200, in which case server terminal 100 is accessed from user terminal 200 by way of communication network 300, and correspondence information that links the event that is to be reported with advertisement information is set in a storage device of server terminal 100 from user terminal 200 (S201).

Upon the occurrence of an event that is to be reported to the user of user terminal 200 (S102), server terminal 100 recognizes the event that has occurred (S103), and refers to correspondence information and specifies the advertisement information that corresponds to the recognized event (S104). Server terminal 100 then executes a process of controlling distribution of the specified advertisement information to user terminal 200 by way of communication network 300 (S105).

User terminal 200 executes processing that accords with the process of controlling distribution that has been executed at server terminal 100 with regard to the advertisement information by, for example, receiving the advertisement information that has been transmitted from server terminal 100 by way of communication network 300 and presenting the advertisement information to the user (S202). The user of user terminal 200 can thus learn of the event that has occurred.

When server terminal 100 distributes advertisement information to user terminal 200, server terminal 100 may charge a prescribed fee to the sponsor of this advertisement information, and all or a portion of the profit resulting from these charges may be restored to the user of user terminal 200 to which the advertisement information has been distributed. The adoption of this form would allow, for example, the distribution of advertisement information to the user of user terminal 200 at no charge, or the report of the occurrence of an event that is concealed by an advertisement. By adopting this form, an increase can be anticipated in the number of people who would use services in which events are reported by means of advertisement distribution.

Details of a working example of the present invention are next described with reference to the accompanying figures.

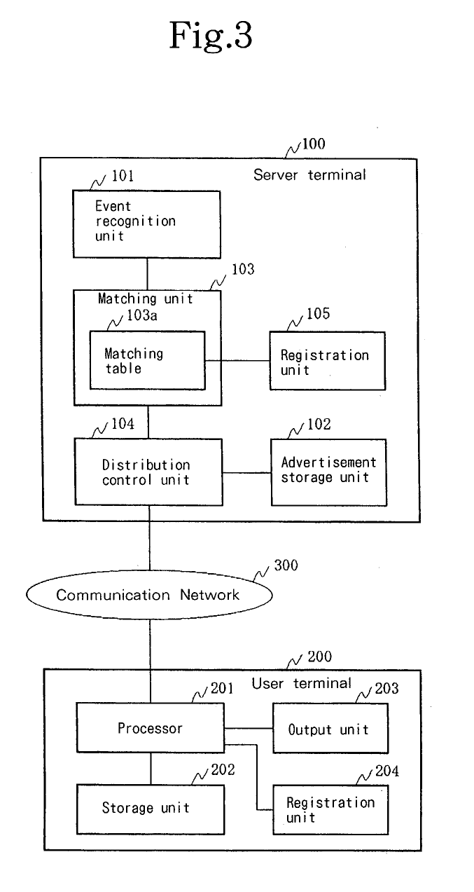

Referring now to FIG. 3, in an advertisement distribution system according to a working example of the present invention, server terminal 100 and user terminal 200 are connected together so as to allow mutual communication by way of communication network 300 such as a mobile communication network or the Internet; server terminal 100 being constituted by event recognition unit 101, advertisement storage unit 102, matching unit 103 that includes matching table 103a, distribution control unit 104, and registration unit 105; and user terminal being constituted by processor 201, storage unit 202, output unit 203, and registration unit 204. Although only one user terminal 200 is shown in FIG. 3, a plurality of user terminals 200 is typically connected to server terminal 100 by way of communication network 300.

First, regarding the internal constitution of server terminal 100, event recognition unit 101 is a component for recognizing an event that is to be reported from server terminal 100 to user terminal 200, a recognized event being transferred to matching unit 103 as event information.

Advertisement storage unit 102 stores one or a plurality of items of advertisement information that an advertiser wishes to distribute and that can be distributed by way of communication network 300.

Correspondence information, which links event information that has been transferred from event recognition unit 101 with advertisement information that has been stored in advertisement storage unit 102, is stored in matching table 103a for each user terminal 200.

Registration unit 105 is a component for registering in matching table 103a correspondence information that links event information and advertisement information, and altering or deleting correspondence information that has been registered in accordance with instructions from the user of user terminal 200.

When event information is transferred from event recognition unit 101, matching unit 103 refers to matching table 103a, determines, for each user terminal 200, correspondence information that links event information and advertisement information, and transfers information for specifying the user terminal and the correspondence information to distribution control unit 104.

When information for specifying the user terminal and correspondence information are transferred from matching unit 103, distribution control unit 104 fetches the advertisement information that is stored in advertisement storage unit 102 based on the correspondence information for each user terminal and transmits this advertisement information by way of communication network 300 to user terminal 200.

Next, regarding the internal constitution of user terminal 200, storage unit 202 is a component for storing advertisement information that has been transmitted in from server terminal 100 by way of communication network 300.

Registration unit 204 is a component for registering in matching table 103a of server terminal 100 correspondence information that links event information with advertisement information, and modifying or deleting correspondence information that has been registered.

Output unit 203 is a device for allowing the user of user terminal 200 to view advertisement information, and is constituted to include, for example, a display device and a speaker. Other types of output devices such as a printer may be provided. The display device is also used when registering correspondence information by means of registration unit 204.

Processor 201 is connected to storage unit 202, output unit 203, and registration unit 204, and is a component for exercising overall control over user terminal 200.

The construction and functions of each unit of the present working example are next described in detail.

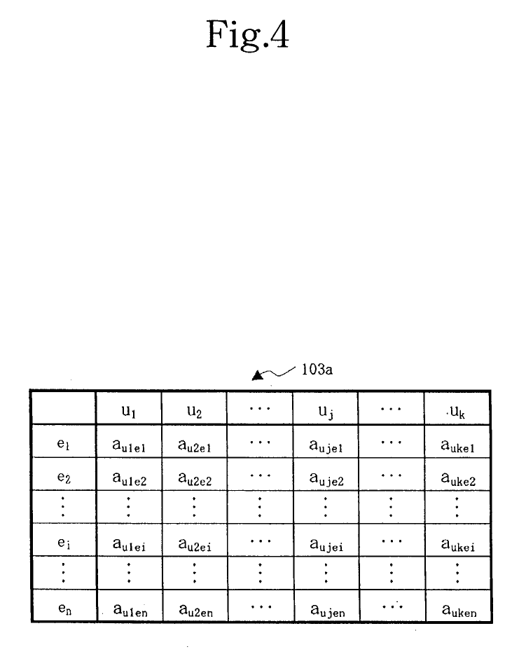

Explanation first regards matching table 103a. As shown in FIG. 4, one example of matching table 103a is a two-dimensional matrix table of n rows and k columns, one item of event information e₁-eₙ being set in each row of the first to nth rows, information u1-uk for specifying one user terminal being set in each column of the first to kth columns, and one item of correspondence information aᵤⱼₑᵢ (where i=1−n and j=1−k) being set at the intersection of each row and each column.

Correspondence information aᵤⱼₑᵢ is either a value indicating one particular item of advertisement information Aᵤⱼₑᵢ that is stored in advertisement storage unit 102 or a value indicating that an advertisement is not to be distributed. For example, when event information eᵢ occurs, correspondence information aᵤⱼₑᵢ, which indicates advertisement information Aᵤⱼₑᵢ, is stored in row eᵢ and column uⱼ if the advertisement information Aᵤⱼₑᵢ is to be distributed to user terminal uⱼ; and correspondence information aᵤⱼₑᵢ, which indicates that advertisement information is not to be distributed, is stored in row eᵢ and column uⱼ if advertisement information is not distributed. In other words, matching table 103a of FIG. 4 is a table for showing which advertisement information is to be distributed, or that advertisement information is not to be distributed, to a certain user terminal when a certain event occurs. Advertisement information is in some cases not sent when a particular event occurs because the user of the user terminal has not requested that an event be reported.

When advertisement information is set in correspondence information auje1-aujen for different event information e1-en at the same user terminal uⱼ, each item of correspondence information auje1-aujen is set to indicate different advertisement information for each case in order that events may be distinguished by the advertisement information. This differentiation is not necessary between different user terminals, and correspondence information that indicates the same advertisement information may be set for different event information e₁-eₙ. For example, the same advertisement information may be linked in correspondence information aᵤ₁ₑ₂, aᵤ₃ₑ₄ and aᵤ₅ₑ₃. On the other hand, the same correspondence information can be set such that the same advertisement information is distributed for the same event information of a plurality of user terminals.

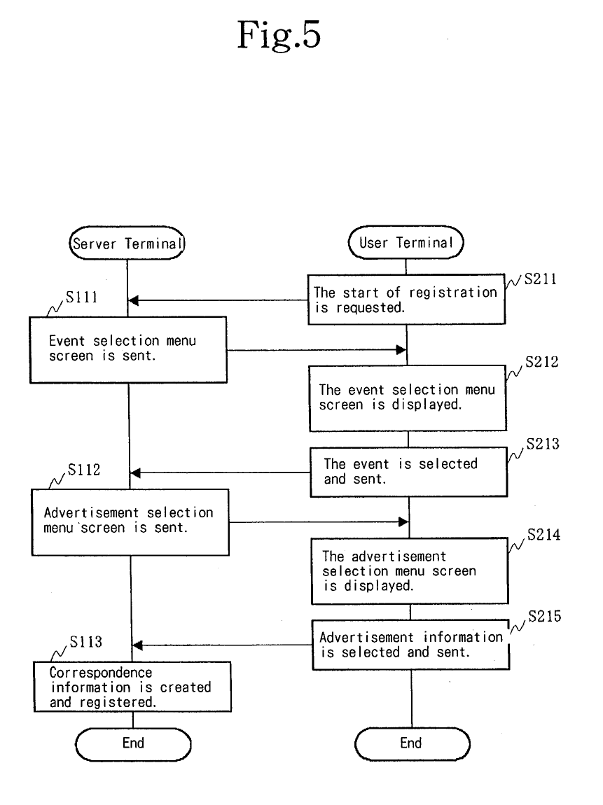

In the case of the present working example, each of the users of user terminals 200 can individually register correspondence information for each user terminal in matching table 103a such as shown in FIG. 4. This point is further explained with the progression of the flow chart of FIG. 5.

In the initial state of matching table 103a, for example, all items of correspondence information aᵤⱼₑᵢ (where i=1−n and j=1−k) in FIG. 4 are set to values such that advertisements are not distributed. When a user of user terminal 200 instructs the start of registration of correspondence information to registration unit 204, registration unit 204, through processor 201, accesses registration unit 105 of server terminal 100 by way of communication network 300, and transmits a request to start registration together with information specifying that user terminal 200 (S211).

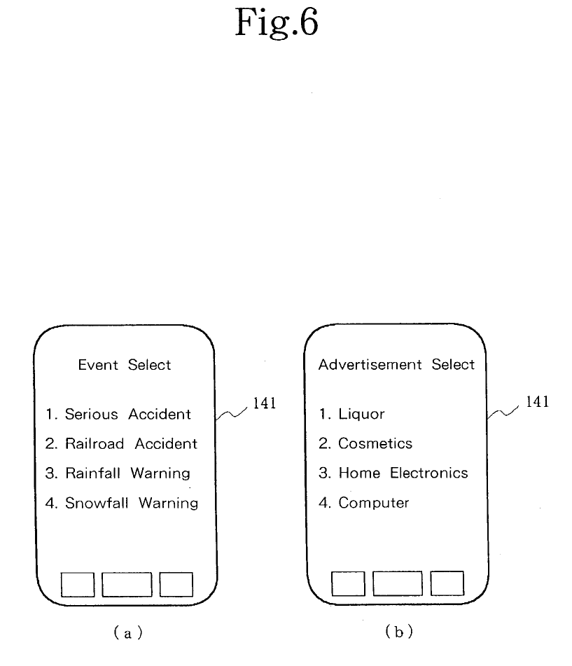

In response, registration unit 105 of server terminal 100 transmits an event selection menu screen that lists the events that correspond to the event information that is set in each row of matching table 103a to user terminal 200 by way of communication network 300 (S111). Registration unit 204 of user terminal 200 displays event selection menu screen 141 that has been received as shown, for example, in FIG. 6(a), on the display device of output unit 203 (S212).

The user of user terminal 200 then selects the event that he or she wishes to have reported on the event selection menu screen, and, when the user operates the transmission button on the same screen, registration unit 204 transmits the information of the selected event to server terminal 100 (S213). Registration unit 105 of server terminal 100 temporarily saves the selected information of the event that has been received and transmits to user terminal 200 the advertisement selection menu screen that lists advertisement information that can be linked and that is stored in advertisement storage unit 102 (S112). Registration unit 204 of user terminal 200 displays advertisement selection menu screen 141 that has been received as shown, for example, in FIG. 6(b) on the display device of output unit 203 (S214).

The user of user terminal 200 next selects the desired advertisement information on the advertisement selection menu screen, and when the user operates the transmission button on the same screen, registration unit 204 transmits the information of advertisement information that has been selected to server terminal 100 (S215). Based on the selected information of the advertisement information that has been received and selected information of events that has been saved, registration unit 105 of server terminal 100 determines the correspondence information and the locations in matching table 103a in which this correspondence information is to be set and rewrites the correspondence information in the relevant locations in matching table 103a (S113).

By repeating the above-described operations for each event for which reporting is desired, the user of user terminal 200 can register correspondence information in matching table 103a for all events for which reporting is desired.

Although the selection of events for which reporting is desired and the selection of advertisement information that is linked to these events were carried out by separate menu screens in the foregoing explanation, this selection may also be carried out on a single menu screen. Further, the selection of a plurality of events for which reporting is desired and the selection of advertisement information that is linked to each of these events may be carried out together on a single menu screen.

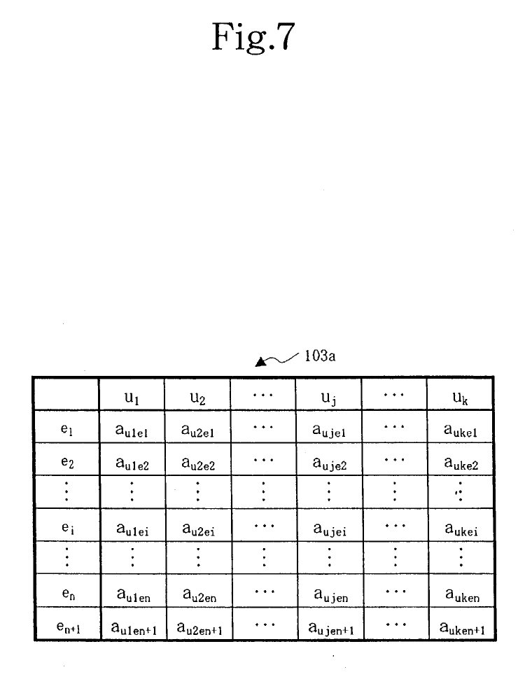

Although events that the user of user terminal 200 can select were limited to events that were set in matching table 103a in the preceding explanation, it is also possible for the user of user terminal 200 to newly register any desired event even if the event has not been set in matching table 103a as long as the event can be recognized by event recognition unit 101 of server terminal 100, and it is also possible to register advertisement information that corresponds to an event that has been newly registered. In such a case, the user designates any desired event in Step S213 of FIG. 5 and transmits to server terminal 100. When a new event has been designated, registration unit 105 of server terminal 100 adds a row for this new event eₙ₊₁ to matching table 103a as shown in FIG. 7. At this time, all of the correspondence information of this row is initialized to values such that advertisement information is not distributed.

When the user of user terminal 200 selects advertisement information that corresponds to new event eₙ₊₁, correspondence information that indicates the advertisement information is set in a location corresponding to the column of that user terminal 200 in the row that was added for new event eₙ₊₁. After a row for new event eₙ₊₁ has been added to matching table 103a in this way, an event selection menu screen that includes the newly added event eₙ₊₁ is created when the processing of FIG. 5 starts in the same user terminal 200 or another user terminal 200. As a result, another user can learn of the existence of an event item that has been added by a certain user, and moreover, can opt for reporting of this event.

Although explanation was presented in FIG. 5 regarding processing for newly registering the correspondence between an event and advertisement information, the modification of correspondence information that has already been registered or operations to rewrite correspondence information such that advertisements are not distributed can also implemented on-line by accessing registration unit 105 of server terminal 100 from registration unit 204 of user terminal 200.

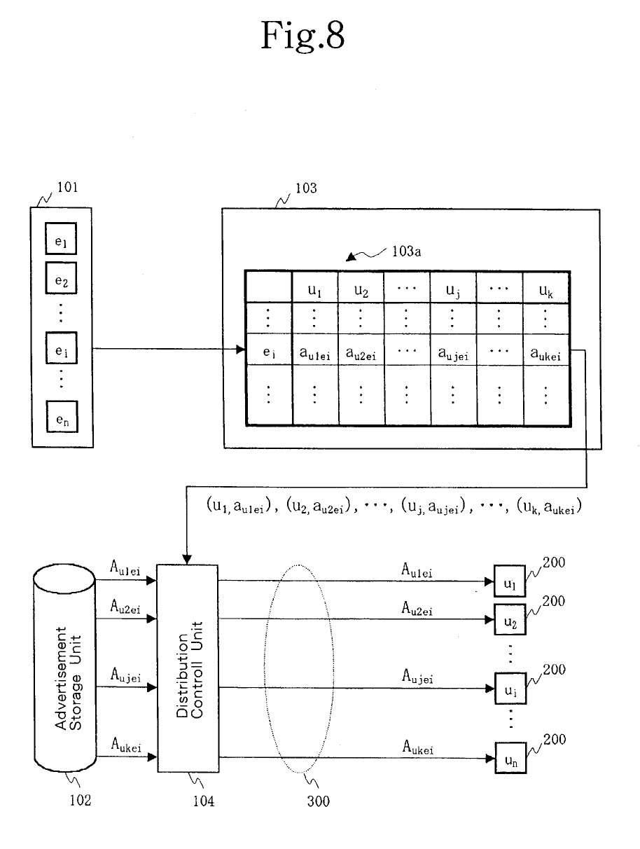

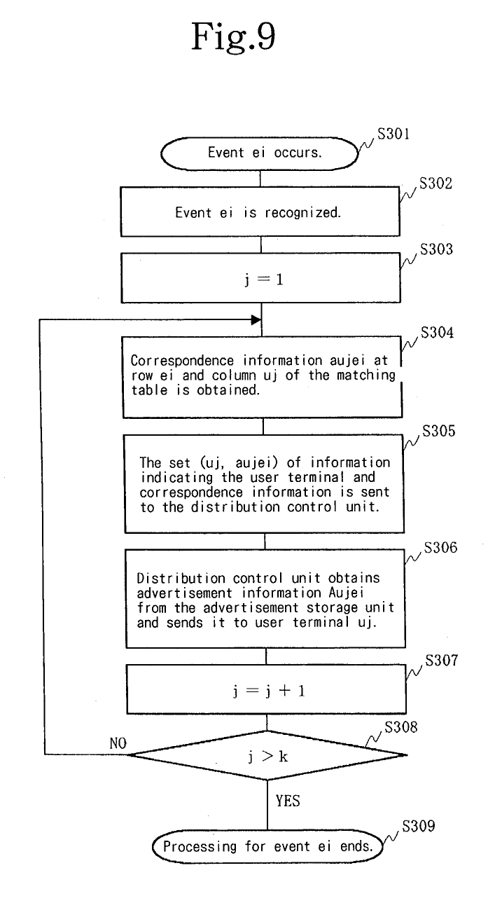

We next refer to FIG. 8 and FIG. 9 to explain details regarding the operation of the present working example for distributing advertisement information instead of reporting an event, using as an example matching table 103a of FIG. 4 that has been prepared as described hereinabove.

Event recognition unit 101 of server terminal 100 performs processing for recognizing the occurrence of events e₁-eₙ by means of detection by observation and measurement, by spontaneous occurrence, or by a report from another system, person, or facility. If it is assumed that a certain event, for example, event eᵢ, now occurs (S301), and that event recognition unit 101 recognizes this occurrence and transfers event information eᵢ to matching unit 103 (S302).

When event information eᵢ is transferred from event recognition unit 101, matching unit 103 sets variable j for directing attention to each individual user terminal 200 to 1, whereby attention is first directed to user terminal 200 of column u1 of matching table 103a (S303), acquires correspondence information au1ei of the intersection of this column u1 and the row of event information eᵢ (S304), and transfers to distribution control unit 104 the set (u₁, aᵤ₁ₑᵢ) that is composed of this and information u₁ of the user terminal (S305).

When the set (u₁, aᵤ₁ₑᵢ) of the information that indicates the user terminal and the correspondence information is transferred from matching unit 103, and if correspondence information au1ei indicates advertisement information Aᵤ₁ₑᵢ and is not a value indicating that advertisement is not to be distributed, distribution control unit 104 obtains advertisement information Aᵤ₁ₑᵢ that is indicated by correspondence information aᵤ₁ₑᵢ from advertisement storage unit 102 and distributes advertisement information Aᵤ₁ₑᵢ to user terminal 200 that is specified by information uⱼ by way of communication network 300 (S306). When advertisement information Aᵤ₁ₑᵢ is transmitted in from distribution control unit 104 of server terminal 100 by way of communication network 300, processor 201 of user terminal 200 receives this information and, by outputting from output unit 203, allows the user to view and/or listen to the information. The user of user terminal 200 thus can learn of the occurrence of event eᵢ. When the processing of Step S306 has been completed, distribution control unit 104 returns the control to matching unit 103. On the other hand, if correspondence information au1ei is a value indicating that an advertisement is not to be distributed, distribution control unit 104 skips the processing of Step S306 and returns the control to matching unit 103, whereby advertisements are not distributed to user terminals 200 that do not desire the report of event eᵢ.

When control is returned from distribution control unit 104, matching unit 103 increments variable j by 1 (S307) and then determines whether or not the value of variable j has exceeded the number of columns k (the number of user terminals) that are registered in matching table 103 (S308). If k has not been exceeded, the process returns to Step S304, whereby attention is directed to user terminal 200 of the next column u₂ of matching table 103a and processing similar to that described above is repeated. When the above-described processing has been repeated for all user terminals that are registered in matching table 103a and variable j has exceeded k, processing for event eᵢ that has been recognized this time is completed (S309).

Although the determination of whether or not the correspondence information was a value indicating that advertisements were to be distributed was carried out at distribution control unit 104 in the foregoing explanation, this determination may be executed at matching unit 103, and when the correspondence information indicates that advertisements are not to be distributed, Steps S305 and S306 may be skipped.

Further, although distribution control unit 104 obtains information indicating the user terminal and correspondence information (uⱼ, aᵤⱼₑᵢ) from matching unit 103, obtains advertisement information Aᵤⱼₑᵢ indicated by correspondence information aᵤⱼₑᵢ from advertisement storage unit 102, and distributes advertisement information Aᵤⱼₑᵢ to user terminal uⱼ in the foregoing explanation, the present invention is not limited to this form. For example, the set of information (uⱼ, aᵤⱼₑᵢ) that indicates the user terminal and the correspondence information indicating advertisement information Aᵤⱼₑᵢ may all be transferred to advertisement storage unit 102 from matching unit 103; and in advertisement storage unit 102, distribution information (Aₘ: u₁, u₂, , uⱼ, ) that indicates advertisement information Am that is to be distributed and the user terminals uⱼ that are the targets of the distribution may be transferred to distribution control unit 104 for each user terminal that is to receive the same advertisement information. Adopting this form allows a simplification of processing and an increase in the speed of operation when distributing to a plurality of user terminals identical advertisement information that is linked to the same event.

Although correspondence information that is stored in matching table 103a can be registered and modified from a user of user terminals 200 in the above-described working example, the correspondence information may also be defined for each user terminal by an advertiser or operator of server terminal 100 and modification from the user of user terminal 200 disallowed. In such a case, the correspondence information may also be defined such that the same advertisement information is distributed to a plurality of user terminals 200 for the same event.

Although advertisement information that is stored in advertisement storage unit 102 is distributed in the above-described working example, the present invention is not limited to this form, and, as an example, advertisement information that is linked to correspondence information that is stored in matching table 103a may be prepared in an advertiser server (not shown in the figure) that is connected to communication network 300 and the advertisement information may be obtained from this advertiser server and distributed to user terminals 200.

Although the actual advertisement information itself was distributed in the above-described working example, the URL to this advertisement information may be distributed to user terminals 200 as the advertisement information. In this case, the users of user terminals 200 use the URL that has been distributed to access the actual advertisement information, recognize the actual advertisement information, and thus recognize the event that has been reported.

Although a matching table such as shown in FIG. 4 was used to link event information and advertisement information for each user terminal 200 in the above-described working example, the method of linking together a user terminal, event information, and advertisement information and the table structure that is used in this method are not limited to the forms in the above-described working example, and various additions and modifications are possible. Other examples of linking are described below.

In matching table 103a that is shown in FIG. 4, correspondence information is set between events and advertisement information for each individual user terminal 200. In other words, if advertisement information Aᵤⱼₑᵢ was to be distributed to user terminal uⱼ when event eᵢ occurred, correspondence information aᵤⱼₑᵢ indicating advertisement information Aᵤⱼₑᵢ was stored in row eᵢ and column uⱼ. However, user terminals 200 may be divided into a number of user groups, and the correspondence information for events and advertisement information may be set in units of user groups. An example of this form is shown in FIG. 10. In the matching table 103b shown in FIG. 10, a plurality of user terminals 200 are divided into a user groups u₁-uₖ according to group definition 131, user terminals 200 that belong to each user group are defined by user definition 132, and the correspondence information aᵤⱼₑᵢ for each event eᵢ and advertisement information is set for each user group. Essentially, if advertisement information Aᵤⱼₑᵢ is to be distributed to user terminals 200 that belong to user group uⱼ when event eᵢ occurs, correspondence information aᵤⱼₑᵢ indicating advertisement information Aᵤⱼₑᵢ is stored at row eᵢ and column uⱼ. In this case, the same advertisement information Aᵤⱼₑᵢ is distributed to all user terminals 200 that belong to user group uⱼ when event eᵢ occurs. Storing a plurality of user terminals in the matching table as a single user group in this way reduces the amount of information that is stored in the matching table and enables a reduction in the amount of processing when creating, amending, and searching the matching table.

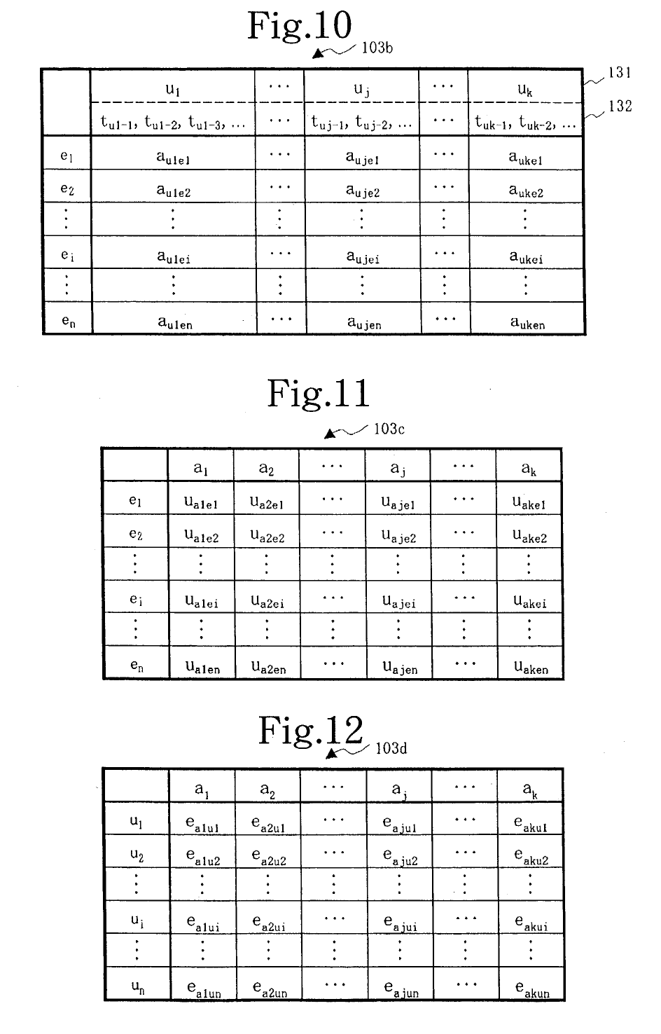

Although event information and user terminals are set in the rows and columns of the matching table and correspondence information that links the events and advertisement information is set at the intersections of the rows and columns in matching table 103a shown in FIG. 4, the present invention is not limited to this form, and the mapping of the event information, user terminals, and correspondence information to the rows, columns, and intersections of the matching table is open to modification. For example, the matching table can be mapped as shown in FIG. 11 and FIG. 12.

In matching table 103c of FIG. 11, event information eᵢ is set in each row, correspondence information aⱼ for linking event information and advertisement information is set in each column, and information uₐⱼₑᵢ indicating user terminals is set at the intersections of rows and columns. In this case, if user terminals 200 exist that desire the transmission of a certain item of advertisement information Aⱼ in place of a report of this event when event eᵢ occurs, information uₐⱼₑᵢ that indicates the relevant user terminals 200 is stored at the intersection of the column of correspondence information aⱼ that indicates this advertisement information Aⱼ and the row of event eᵢ. One or a plurality of user terminals may be stored at the intersection of row eᵢ and column aⱼ. The adoption of this form enables a reduction of the number of times that advertisement storage unit 102 must be accessed when the same advertisement information that is linked to the same event is to be distributed to a plurality of user terminals.

In matching table 103d of FIG. 12, information uᵢ of user terminals is set in each row, correspondence information aⱼ linking event information and advertisement information is set in each column, and event information eₐⱼᵤᵢ is set at the intersections of each row and column. Essentially, the matching table is constituted such that the distribution to user terminal uᵢ of advertisement information Aⱼ that is indicated by correspondence information aⱼ is determined by recognition of the occurrence of event eₐⱼᵤᵢ that is stored at the intersection of row uᵢ and column aⱼ. In this case, if the occurrence of event eₐⱼᵤᵢ is recognized, event eₐⱼᵤᵢ is searched from matching table 103d, and advertisement information Aⱼ that is indicated by the correspondence information aⱼ of column aⱼ of the searched location is distributed to the user terminals uᵢ of row uᵢ of the searched location. The adoption of this form enables rapid response when there is an inquiry from the user of a user terminal regarding an event that corresponds to advertisement information that has been distributed.

Although one item of advertisement information is linked to one item of event information and one item of advertisement information is distributed to user terminals for the occurrence of one event in the above-described working examples, the present invention is not limited to this form, and it is also possible for one item of advertisement information to be distributed when a logical condition of a plurality of items of event information has been realized. The logical condition in such a case may be, for example, a logical sum, a logical product, or a logical NOT. For example, advertisement information Am is distributed if event e₁ and event e₂ both occur (logical product), or advertisement information Am is distributed when either one of event e₁ and event e₂ occurs. In this case, the logical condition of a plurality of events may be set in a section for setting event information as shown in matching table 103e of FIG. 13, it may be determined in matching unit 103 whether or not the logical condition for the plurality of events that has been set in matching table 103e has been realized, for example, with each new recognition of an event, and advertisement information that corresponds to a logical condition that has been realized may then be distributed. The adoption of this form enables reporting of the occurrence of more complex events.

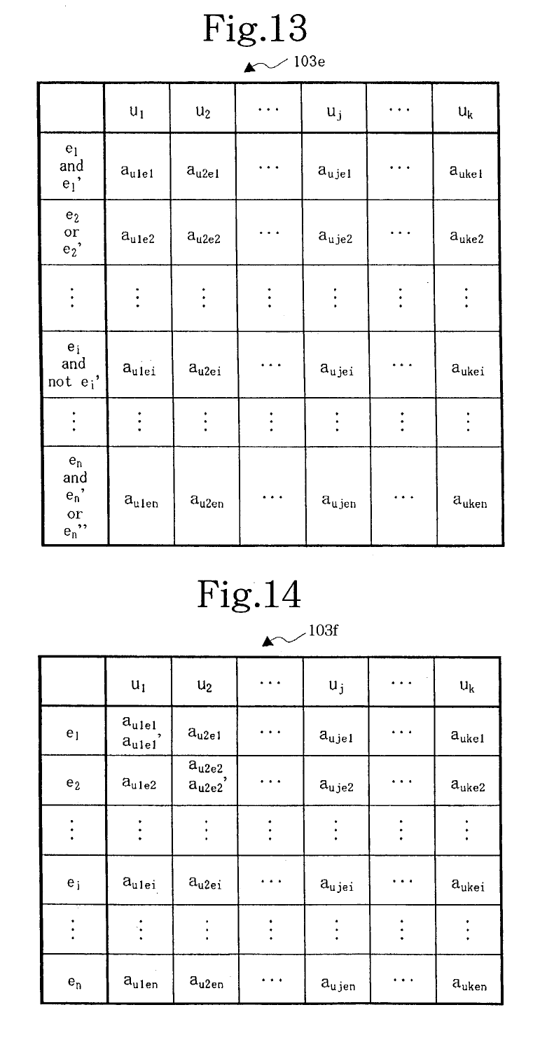

Although one item of advertisement information is linked to one item of event information and one item of advertisement information is distributed to user terminals for the occurrence of one event in the above-described working example, the present invention is not limited to the form, and a plurality of items of advertisement information may be distributed for one item of event information. As an example, advertisement information Aₘ₁ and advertisement information Aₘ₂ may be distributed when event e1 occurs. In this case, as shown by the example of correspondence information that has been set at the intersection of row e₁ and column u₁ or at the intersection of row e₂ and column u₂ of matching table 103f of FIG. 14, correspondence information (aᵤ₁ₑ₁, a_{ufe1}′) and (aᵤ₂ₑ₂, aᵤ₂ₑ₂′) may be set that links a plurality of items of advertisement information to one item of event information. The adoption of this form enables the distribution of more items of advertisement information.

Further, correspondence information that links a plurality of advertisement information as in FIG. 14 may be set in the correspondence information of matching table 103e of FIG. 13; or alternatively, a plurality of items of event information as in FIG. 13 may be set in the section for event information of matching table 103f of FIG. 14, whereby more items of advertisement information can be distributed upon the occurrence of a more complex event.

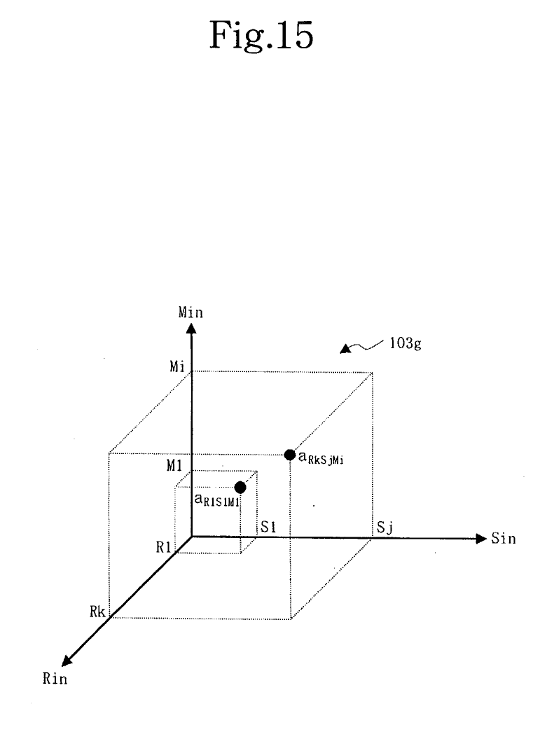

Although a two-dimensional matrix table was used for linking event information and advertisement information for each user terminal in the above-described working example, a matrix table having three or more dimensions may also be used. For example, the present invention may be applied to a person-to-person message reporting service in which, rather than server terminal 100 transferring a certain specific message without alteration that has been transmitted in from a sending user to a receiving user, it is possible to transmit advertisement information that has been linked in advance to combinations of the three elements: sending user, message content, and receiving user. In this case, the event “a certain message has been transmitted from a certain sending user to a certain receiving user” may be recognized at server terminal 100, and the advertisement information that corresponds to this event may then be distributed to the receiving user. If a three-dimensional matrix table construction is employed, the correspondence of this type of event and advertisement information may be easily implemented by means of matching table 103g having a logical construction such as shown in FIG. 15.

In FIG. 15, Min is the axis of the message content, Rᵢₙ is the axis of the receiving user, and Sᵢₙ is the axis of the sending user; a_{R1S1M1} is correspondence information that indicates advertisement information A_{R1S1M1} that corresponds to the set of message content M1, receiving user R₁, and sending user S₁; and a_{RkSjMi} is correspondence information indicating advertisement information A_{RksjMi} that corresponds to the set of message content Mi, receiving user Rₖ, and sending user Sⱼ. This matching table 103g is equivalent to the function shown in the following formula if it is considered as a function f that returns the correspondence information a_{RkSjMi} upon receiving user Rₖ, sending user Sⱼ, and message content Mᵢ as the parameter input.

f(Rₖ, Sⱼ, Mᵢ)=a_{RkSjMi}

Further, as with the method that was explained with reference to FIG. 5, the registration of correspondence information to matching table 103g can be carried out for each receiving user, and the registration of correspondence information may be carried out by a sending user.

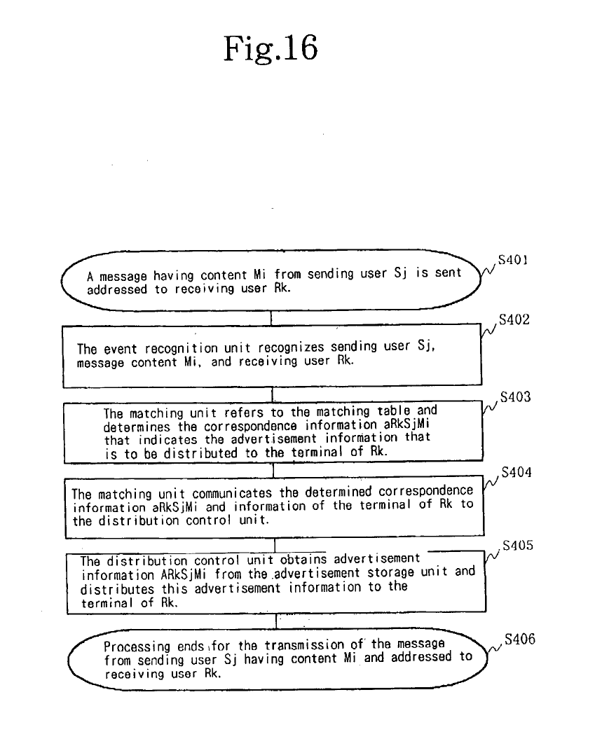

FIG. 16 is a flow chart showing an example of a process in which matching table 103g shown in FIG. 15 is used for distributing advertisement information in place of a process in which server terminal 100 reports to a receiving user a message that has been transmitted in from a sending user. When an event occurs in which a message addressed to receiving user Rₖ and having content Mᵢ is transmitted from sending user Sⱼ (S401), event recognition unit 101 of server terminal 100, which functions as a message relay server, recognizes the occurrence of an event in which the sending user is Sⱼ, the message content is Mᵢ, and the receiving user is Rₖ, and transfers the event to matching unit 103 (S402).

Referring to matching table 103g of FIG. 15, matching unit 103 determines correspondence information a_{RkSjMi} that corresponds to receiving user Rₖ, sending user Sⱼ and message content Mᵢ (S403); and transfers to distribution control unit 104 correspondence information a_{RkSjMi} that has been determined and information of the terminal of receiving user Rₖ.

Distribution control unit 104 retrieves advertisement information A_{RkSjMi} that corresponds to correspondence information a_{RkSjMi} from advertisement storage unit 102, and distributes the retrieved advertisement information A_{RkSjMi} to terminal 200 of receiving user Rₖ by way of communication network 300 (S405).

Server terminal 100 thus completes the processing for a message having content Mᵢ from sending user Sⱼ that has been transmitted addressed to receiving user Rₖ (S406).

By setting the event “A message addressed to receiving user Rₖ and having content Mᵢ has been transmitted from sending user Sᵢ” in event eᵢ of FIG. 4, setting correspondence information a_{RkSjMi} in column uₖ that corresponds to receiving user Rₖ of each of the columns of row eᵢ, and setting correspondence information indicating that an advertisement is not to be distributed in the columns corresponding to other users, a message transfer service such as described in the foregoing explanation can be realized by the process of FIG. 9. Further, if receiving user Rₖ is not limited to one user but made a user group that is constituted by a plurality of users, a message that is outputted addressed to the user group can be reported as advertisement information to each of the users that are the constituent members of that group; and the advertisement information that is distributed can also be not one item of advertisement information but a plurality of items of advertisement information.

Although one matching table is used to manage the correspondence between events and advertisement information for each of one or a plurality of user terminals in the above-described working example, management can also be realized by means of a matching table for each individual user terminal or for a plurality of user terminals.

Although the correspondence between events and advertisement information was managed for one or a plurality of user terminals in the above-described working example, the correspondence between events and advertisement information can also be managed such that the correspondence is absolutely the same for all user terminals.

Explanation next regards another working example of the distribution control process.

When distributing the corresponding advertisement information to the corresponding user terminals upon the occurrence of an event in the previously described working examples, prescribed advertisement information may be distributed at a stage in which the event has not yet occurred and the distributed advertisement information then switched by the occurrence of the event. Alternatively, when the occurrence of an event is recognized, corresponding advertisement information may be continuously distributed to corresponding user terminals while this event is ongoing. Alternatively, when the occurrence of an event is recognized, corresponding advertisement information may be continuously distributed to corresponding user terminals for a prescribed period of time. Adopting these forms enables an advertiser to distribute more advertisements.

Further, as previously described, advertisement information may be distributed to user terminals at a stage in which the event has not yet occurred and the distribution of the advertisement information then halted when the event occurs. In this case, the distribution of the advertisement information may be halted while an event is occurring, or the distribution of advertisement information may be halted for only a prescribed time period when the event occurs. Alternatively, the advertisement information may be distributed when the occurrence of the event has ended, or the distribution of the advertisement information may begin when the occurrence of the event has ended.

Although advertisement information was distributed from server terminal 100 by way of communication network 300 in the above-described working example, advertisement information that corresponds to an event that is to be reported may be downloaded in advance from server terminal 100 or a different server to storage unit 202 of each user terminal 200, following which server terminal 100 transmits to user terminal 200 only a request to reproduce the advertisement information when the event occurs and does not transmit the advertisement information itself. Similarly, when halting distribution when an event occurs, only a request to halt reproduction need be transmitted to user terminal 200 rather than halting the transmission of the advertisement information.

In the above-described working example, when an event that is to be reported occurs and is recognized by server terminal 100, control over distribution of advertisement information that corresponds to the event from server terminal 100 to a user terminal was carried out spontaneously. However, the present invention is not limited to this type of “push-type” distribution and can also be applied to a “pull-type” distribution in which advertisement information is distributed instead of a report of an event at the time that user terminal 200 requests report of an event. In such a case, server terminal 100 recognizes whether or not the event has occurred at the time that a report of the event is requested from user terminal 200 and distributes advertisement information that corresponds to the event if the event has occurred, but, if the event has not occurred, distributes a message indicating that the event has not occurred or distributes other advertisement information that has been set in advance. Alternatively, server terminal 100 may be a mail server, and when a request to receive mail is sent from user terminal 200 to server terminal 100, server terminal 100 may distribute advertisement information to user terminal 200 in place of the message “You have no mail” when not a single item of received mail has arrived.

Although only advertisement information was distributed in place of a report of an event in the above-described working example, information other than advertisements may also be included in the advertisement information that is distributed. Examples of information other than advertisements that can be considered include: information relating to the user's registration such as the day and time that the user of a user terminal registered the correspondence between an event and advertisement information in the server terminal, the number of the selected event, or the user's comments that were separately applied as input when registering, or fragments of event information that by themselves do not make the event information that is to be reported easily understandable to an outside party.

In the above-described working example, each of the above-described functions of the server terminal and user terminal relating to the present invention may be realized by hardware, or may be realized by means of software through the use of a computer and program. In such a case, the computer for the server terminal can be constituted by a personal computer or work station in which a CPU, main memory, external storage device, and a device for connecting to a communication network are interconnected by a bus; and the program for the server terminal can be stored on the external storage device, can be read to the main memory when the program is to be executed, and can control the operations of the computer to cause the computer to function as the server terminal according to the present invention. In addition, the computer for the user terminal can be constituted by, for example, a personal computer, a portable data terminal, or portable telephone in which a CPU, main memory, external storage device, and device for connecting to a communication network are interconnected by a bus; and the program for the user terminal can be stored in the external storage unit, read to the main memory when the program is to be executed, and can control the operations of the computer to cause the computer to function as the user terminal according to the present invention.

Examples of the Application of the Working Examples

Several examples of the application of the working examples of the present invention are next described. It will be obvious that the application of the present invention is not limited to only the examples described below.

(1) Server terminal 100 provides an event-reporting service to a user of user terminal 200 who has requested information on stock prices in which user terminal 200 of the user is notified by means of the distribution of advertisement information that the stock price for an issue that has been designated in advance has reached a designated level. “Ichiro,” who is a user of this service, has registered a correspondence of event and correspondence information to server terminal 100 in advance such that advertisement information Z1 will be distributed if the stock price of issue X1 surpasses a designated level Y1. As advertisement information Z1, Ichiro has designated the advertisement information of an automobile manufacturer that he likes. When server terminal 100 recognizes the event that issue X1 has surpassed level Y1, it distributes advertisement information Z1 to Ichiro's user terminal 200. Ichiro views and/or listens to advertisement information Z1 that has been distributed and recognizes that issue X1 has surpassed level Y1. In addition, the information that a limited automobile model will soon available is also included in advertisement information Z1, and because this advertisement information is an advertisement for an automobile manufacturer that he likes, Ichiro views this information with great interest. The advertiser is therefore able to more effectively publicize a product, and Ichiro is able to learn from the distribution of this advertisement information Z1 that a limited model will be marketed at the same time that he is informed of the event information.

(2) Server terminal 100 provides a message transfer service for converting a certain specific message that has been sent in from a sending user to advertisement information and transferring to a receiving user. Hanako, who is a user of this service, has registered in advance in server terminal 100 a correspondence of event and correspondence information such that advertisement information Z2 will be distributed to her own portable terminal when she is sent the message Y2 “I want you to telephone me” that is addressed to her from Ichiro, who is also a user of this service. In addition, Hanako has an interest in cosmetics and has therefore selected advertisement information on cosmetics as advertisement information Z2. When message Y2 “I want you to telephone me” addressed to Hanako is transmitted in from Ichiro, server terminal 100 recognizes this transmission as an event and distributes advertisement information Z2 to the portable terminal that is Hanako's user terminal 200. Hanako views and/or listens to advertisement information Z2 that has been distributed and recognizes that Ichiro has sent a message addressed to her indicating that he wants her to call him. When she views and/or listens to advertisement information Z2, Hanako happens to be having a meal with friends. The advertisement information is therefore seen or heard by her friends, but this information is perceived by her friends to be nothing more than advertisement information and its significance is therefore not understood by the others. In addition, because advertisement information Z2 is an interesting advertisement about cosmetics, Hanako and her friends continue with their meal talking about cosmetics. The advertiser is therefore able to more effectively publicize a product, and Hanako, thanks to the distribution of this advertisement information Z2, has been able to secretly recognize a message from Ichiro as well as see advertisement information about cosmetics, a product that she likes.

(3) Server terminal 100 provides a service of using the distribution of advertisement information to report to an unspecified multiplicity of users who have posted inquiries by way of the Internet regarding vacancies in a large-scale underground parking lot of a certain shopping center. In this service, it is assumed that it is widely known that advertisement information Z3 regarding special sales in the shopping center is distributed when there are vacancies in the parking lot, and advertisement information Z4 of other nearby parking lots managed by other companies is distributed when the parking lot is full. Ichiro and Hanako, having gone for a drive, have decided to go shopping in this shopping center, and using the Internet connection capability of the communication data terminal, i.e., user terminal, that is equipped in Ichiro's car, Ichiro accesses server terminal 100 and inquires about the state of vacancies in the large-scale underground parking lot. Server terminal 100 checks the current vacancy state from the parking lot management system that manages the vacancy state in the large-scale underground parking lot, recognizes the event that there are vacancies, and therefore distributes advertisement information Z3 for special sales in the shopping center to the communication data terminal that originated the inquiry. Ichiro views and/or listens to advertisement information Z3 that is distributed to the communication data terminal, understands that there are vacancies in the parking lot, and directs his car toward the parking lot. Hanako, on the other hand, looks at advertisement information Z3 regarding special sales that is displayed and outputted on the communication data terminal and gets an early start on choosing products to buy. Ichiro is therefore able to quickly and smoothly park his car, Hanako is able to purchase products that are on sale, and the advertiser is able to more effectively publicize products.

(4) Server terminal 100 provides a service for download-marketing of software products to users who access by way of the Internet. Ichiro, a user who takes advantage of this service, connects to server terminal 100 from his home personal computer, which is user terminal 200, and carries out procedures to purchase a certain software product B. He uses a credit card to pay the charges. The price of the product is ¥3000, but the price has been discounted ¥200. Server terminal 100, after communicating in a message: that the download of software product B will be executed after downloading advertisement information Z4 of a certain advertiser in a moving picture format, that the start of downloading of software product B will be indicated by the start of reproduction of advertisement information Z4, that the end of downloading of software product B will be indicated by the halt of reproduction of advertisement information Z4, and that the above-described discount results from viewing and/or listening to the advertisement information; downloads advertisement information Z4 to the personal computer belonging to Ichiro, who is the purchaser; transmits a request to Ichiro's personal computer to reproduce advertisement information Z4 upon completing the download of advertisement information Z4; and then immediately begins the download of software product B. Upon completion of the download of software product B, server terminal 100 transmits a request to the personal computer to halt reproduction of advertisement information Z4. Ichiro knows that the download of software product B has started when he sees and/or hears the reproduction of advertisement information Z4 on his personal computer, and recognizes that the download has been completed by the halt of reproduction of advertisement information Z4. Ichiro is not particularly interested in the content of advertisement information Z4, but because he is anxious to know when the download of software product B has been completed, he continues to watch and/or listen from beginning to end. The advertiser thus is able to more effectively publicize a product, and Ichiro, by receiving the distribution of the advertisement information, is able to purchase software product B at a lower price.

As described in the foregoing explanation, the present invention can obtain the following effects:

The attention of a user can be drawn to advertisement information, whereby the effect of an advertisement can be maximized. This result is obtained because, instead of simply executing a process for reporting an event from a server terminal to a user terminal by way of a communication network, a process is executed that controls the distribution to the user terminal of advertisement information that corresponds to the event that is to be reported, whereby the advertisement information that is subjected to this distribution control, rather than being simply incidental information to the user of the user terminal, becomes information that is indispensable to the user for learning about an event that is reported.

The report of an event can be realized in secret free from the concern that information about the reported event will be discovered by other people. This confidentiality can be maintained because, instead of executing a process of reporting the event from the server terminal to the user terminal by way of the communication network, a process is executed for controlling the distribution to the user terminal of advertisement information that corresponds to the reported event.

The two types of information, event information and advertisement information, can be transmitted by only the advertisement information. This double duty is possible because the advertisement information that is subject to distribution control performs both the original role of advertisement information as well as the role of reporting an event.

A constitution in which the user of the user terminal establishes the correspondence between the event and advertisement information can eliminate unpleasantness to the user that is caused by distributing advertisement information that is of no interest to the user.

While preferred embodiments of the present invention have been described using specific terms, such description is for illustrative purposes only, and it is to be understood that changes and variations may be made without departing from the spirit or scope of the following claims.

What is claimed is:

1. A method of distributing advertisements in a system for implementing communication between a server terminal and user terminals by way of a communication network, wherein said server terminal executes a process of controlling distribution of-advertisement information that corresponds to an event to said user terminal.

2. A method of distributing advertisements in a system for implementing communication between a server terminal and user terminals by way of a communication network, wherein, when the occurrence of an event that is to be reported to a user terminal is recognized at said server terminal, said server terminal executes a process of controlling distribution of advertisement information that corresponds to said event to said user terminal.

3. A method of distributing advertisements in a system for implementing communication between a server terminal and user terminals by way of a communication network, wherein, when the occurrence of an event that is to be reported to a user terminal is recognized at said server terminal, said server terminal refers to correspondence advertisements information that links said event, and executes a process of controlling distribution of said advertisement information that corresponds to said event to said user terminal.

4. A method of distributing advertisements according to claim 1, wherein said process of controlling distribution includes a process for transmitting said advertisement information to said user terminal by way of said communication network.

5. A method of distributing advertisements according to claim 1, wherein said process of controlling distribution includes a process for transmitting, to said user terminal by way of said communication network, a request to reproduce said advertisement information that has been stored in advance in said user terminal.

6. A method of distributing advertisements according to claim 1, wherein said process of controlling distribution includes a process for halting the process of transmitting said advertisement information to said user terminal by way of said communication network.

7. A method of distributing advertisements according to claim 1, wherein said process of controlling distribution includes a process for transmitting, to said user terminal by way of said communication network, a request to halt reproduction of said advertisement information that is being reproduced in said user terminal.

8. A method of distributing advertisements according to claim 1, wherein said server terminal refers to correspondence information that links said event and said advertisement information and specifies said advertisement information that corresponds to said event that is to be reported.

9. A method of distributing advertisements according to claim 8, wherein one or a plurality of items of said advertisement information is linked to one said event.

10. A method of distributing advertisements according to claim 8, wherein one or a plurality of items of said advertisement information is linked to a logical condition of a plurality of said events.

11. A method of distributing advertisements according to claim 8, wherein the linking of said event and said advertisement information is implemented for each of one or a plurality of said user terminals.

12. A method of distributing advertisements according to claim 11, wherein linking of said event and said advertisement information for each of one or a plurality of said user terminals is implemented by users of the user terminals.

13. A server terminal for communicating with user terminals by way of a communication network, said server terminal executing a process for controlling distribution of advertisement information that corresponds to an event to said user terminals.

14. A server terminal for communicating with user terminals by way of a communication network, said server terminal being provided with:
event recognition means for recognizing the occurrence of an event that is to be reported to a user terminal; and
distribution control means for executing a process of controlling distribution of advertisement information that corresponds to said event to said user terminals.

15. A server terminal for communicating with user terminals by way of a communication network, said server terminal being provided with:
event recognition means for recognizing the occurrence of an event that is to be reported to a user terminal;
matching means for specifying advertisement information that corresponds to said event; and
a distribution control means for executing a process of controlling distribution of advertisement information that corresponds to said event to said user.

16. A server terminal according to claim 13, wherein said process of controlling distribution includes a process for transmitting said advertisement information to said user terminal by way of said communication network.

17. A server terminal according to claim 13, wherein said process of controlling distribution includes a process for transmitting, to said user terminal by way of said communication network, a request to reproduce said advertisement information that has been stored in advance in said user terminal.

18. A server terminal according to claim 13, wherein said process of controlling distribution includes a process for halting the process of transmitting said advertisement information to said user terminal by way of said communication network.

19. A server terminal according to claim 13, wherein said process of controlling distribution includes a process for transmitting, to said user terminal by way of said communication network, a request to halt reproduction of said advertisement information that is being reproduced in said user terminal.

20. A server terminal according to claim 13, wherein said server terminal:
refers to a matching table wherein correspondence information is registered that links said event and said advertisement information; and
specifies said advertisement information that corresponds to said event that is to be reported.

21. A server terminal according to claim 20, wherein one or a plurality of items of said advertisement information are linked to one said event.

22. A server terminal according to claim 20, wherein one or a plurality of items of said advertisement information are linked to a logical condition of a plurality of said events.

23. A server terminal according to claim 20, wherein linking of said events and said advertisement information is carried out for each one or a plurality of said user terminals.

24. A server terminal according to claim 23, further provided with a registration control means by which users of user terminals implement linking of said events and said advertisement information for each one or a plurality of said user terminals.

25. A user terminal for communicating with a server terminal by way of a communication network, said user terminal being provided with:
registration means for registering, in said server terminal by way of said communication network, correspondence information that links advertisement information with an event for which a report is received from said server terminal; and
processing means for, when said server terminal executes a process for controlling distribution to said user terminal of advertisement information that corresponds to said event, executing a process that accords with the process of controlling distribution that is executed.

26. A user terminal according to claim 25, wherein, when said process of controlling distribution is a process for transmitting said advertisement information to said user terminal by way of said communication network, said processing means performs processing for receiving said advertisement information.

27. A user terminal according to claim 25, wherein, when said process of controlling distribution is a process for transmitting, to said user terminal by way of said communication network, a request to reproduce said advertisement information that has been stored in advance in said user terminal, said processing means performs processing for reproducing said advertisement information that has been stored in advance in said user terminal.

28. A user terminal according to claim 25, wherein, when said process of controlling distribution is a process for halting the process of transmitting said advertisement information to said user terminal by way of said communication network, said processing means halts the process of receiving said advertisement information.

29. A user terminal according to claim 25, wherein, when said process of controlling distribution is a process for transmitting, to said user terminal by way of said communication network, a request to halt the reproduction of said advertisement information that is being reproduced in said user terminal, said processing means halts the reproduction of said advertisement information that is being reproduced.

30. A user terminal according to claim 25, wherein said correspondence information that is registered by said registration means is information that links one or a plurality of items of said advertisement information to one said event.

31. A user terminal according to claim 25, wherein said correspondence information that is registered by said registration means is information that links one or a plurality of items of said advertisement information to a logical condition of a plurality of said events.

32. A program for causing a computer that constitutes a server terminal that communicates with user terminals by way of a communication network to execute a process of controlling distribution of advertisement information that corresponds to events to said user terminals.

33. A program for causing a computer that constitutes a server terminal that communicates with user terminals by way of a communication network to function as:
event recognition means for recognizing the occurrence of events that are to be reported to said user terminals; and
distribution control means for executing a process of controlling distribution of advertisement information that corresponds to said events to said user terminals.

34. A program for causing a computer that constitutes a server terminal that communicates with user terminals by way of a communication network to function as:
event recognition means for recognizing the occurrence of events that are to be reported to said user terminals;
matching means for specifying advertisement information that corresponds to said events; and
distribution control means for executing a process of controlling distribution of advertisement information that corresponds to said event to said user terminals.

35. A program according to claim 32, wherein said process of controlling distribution includes a process for transmitting said advertisement information to said user terminals by way of said communication network.

36. A program according to claim 32, wherein said process of controlling distribution includes a process for transmitting, to said user terminals by way of said communication network, a request to reproduce said advertisement information that has been stored in advance in said user terminals.

37. A program according to claim 32, wherein said process of controlling distribution includes a process for halting a process of transmitting said advertisement information to said user terminals by way of said communication network.

38. A program according to claim 32, wherein said process of controlling distribution includes a process for transmitting, to said user terminals by way of said communication network, a request to halt the reproduction of said advertisement information that is being reproduced on said user terminals.

39. A program according to claim 32, wherein:
a matching table is referred to that registers correspondence information that links said events and said advertisement information; and
said advertisement information that corresponds to said events that are reported is specified.

40. A program according to claim 39, wherein the linking of said event and said advertisement information is implemented for each one or a plurality of said user terminals.

41. A program according to claim 40, said program further causing said computer to function as registration means for enabling users of user terminals to link said events and said advertisement information for each one or plurality of said user terminals.

42. A program for causing a computer that constitutes a user terminal that communicates with a server terminal by way of a communication network to function as:
registration means for registering, in said server terminal by way of said communication network, correspondence information that links advertisement information and events for which reports are received from said server terminal; and
processing means for, when said server terminal executes a process of controlling distribution of advertisement information that corresponds to said event to said user terminal, executing a process that accords with the process of controlling distribution that is executed.

43. A program according to claim 42, wherein, when said process of controlling distribution is a process for transmitting said advertisement information to said user. terminal by way of said communication network, said processing means executes processing for receiving said advertisement information.

44. A program according to claim 42, wherein, when said process of controlling distribution is a process for transmitting, to said user terminal by way of said communication network, a request to reproduce said advertisement information that has been stored in advance in said user terminal, said processing means executes processing to reproduce said advertisement information that has been stored in advance in said user terminal.

45. A program according to claim 42, wherein, when said process of controlling distribution is a process for halting a process of transmitting said advertisement information to said user terminal by way of said communication network, said processing means halts the process for receiving said advertisement information.

46. A program according to claim 42, wherein, when said process of controlling distribution is a process for transmitting, to said user terminal by way of said communication network, a request to halt the reproduction of said advertisement information that is being reproduced on said user terminal, said processing means halts the reproduction of said advertisement information that is being reproduced.
